(19) United States
(12) Patent Application Publication
(10) Pub. No.: US 2021/0224576 A1
(43) Pub. Date: Jul. 22, 2021

(54) OPTIMISATION METHOD

(71) Applicant: Xuan Hung NGUYEN, Ho Chi Minh City (VN)

(72) Inventors: Xuan Hung NGUYEN, Ho Chi Minh City (VN); Quoc Hung NGUYEN, Thu Dau Mot City (VN); Duc Thang LE, Ho Chi Minh City (VN)

(21) Appl. No.: 17/039,667

(22) Filed: Sep. 30, 2020

(30) Foreign Application Priority Data
Jan. 21, 2020 (VN) 1-2020-00471

(51) Int. Cl. G06K 9/62; G06F 17/18; G06F 17/16; G06F 7/24

(52) U.S. Cl. CPC G06K 9/623; G06F 7/24; G06F 17/16; G06F 17/18

(57) ABSTRACT

Meta-heuristic algorithms are simpler and easier than gradient-based ones. Meta-heuristic algorithms strongly demonstrate their robustness in terms of problem solving and decision making. However, it is not easy to make the abovementioned techniques reach their best performance. Described herein is an optimization method for determining an objective solution represented by location of a global optimal solution point and searchable by solution candidates. The method comprises initialising a first of the solution candidates with a trial value with each of the solution candidates having an ordinal rank. The method further comprises updating the position of each candidates using the position of the solution candidate having a rank that is higher thereto, determining value of objective function for each solution candidates, and assigning a new ordinal rank each of the solution candidate based on value of their objective function generated therefrom.

### TECHNICAL FIELD

The present invention relates generally to a meta-heuristic optimization method.

### BACKGROUND

Optimization has an important role in applied mathematics because it provides effective decision support systems in various applications across industry, science, business, and government. There are many kinds of optimization algorithms, from traditional gradient-based algorithms or simplex methods to gradient-free algorithms, which in most parts, belongs to meta-heuristic optimization. Meta-heuristic algorithms are typically much simpler, easier to implement and are better at avoiding the local optimum than traditional gradient-based ones. Because of these outstanding advantages, they have been widely used in the past two decades as robust and reliable methods for a wide range of complicated optimization problems, from single-objective to multi-objective, and with continuous, discrete and mixed design variables.

Taking into account the number of solution candidates used for a search process, meta-heuristic optimization algorithms can be classified under two main groups, namely single-solution-based or trajectory-based and population-based. In the first group, a solution candidate moves through the search space along a trajectory determined by some heuristic rules to find out the global optimization result. Contrarily, population-based algorithms randomly generate a set of individuals in the solution space, and each of them interacts with the others by some mechanisms in order to simultaneously explore and exploit the solution space for finding out the optimal result. This class reveals some advantages with respect to the former one in terms of reaching better exploration ability as well as avoiding locally optimal results, especially when dealing with implicit or combinatorial optimization problems. These superiorities attract researchers to highly focus on developing meta-heuristic algorithms in recent years.

As such, many meta-heuristic optimization methods have been devised, such as Genetic Algorithm (GA), Differential Evolution (DE), Particle Swarm Optimization (PSO), Ant Colony Optimization (ACO), Memetic Algorithm (MA), and Firefly Algorithm (FA), to name a few, Gravity Search Algorithm (GSA), Moth-Flame Optimization, etc. These algorithms have been used in various optimization problems and strongly demonstrated their robustness in terms of problem solving and decision making. However, the way to make the abovementioned techniques reach their best performance with respect to a certain optimization problem is not easy and time-consuming sometimes. This is due to parameters-dependent problems in the aforementioned algorithms. For instance, GA, DE, and MA need at least mutation and crossover probabilities; PSO requires inertia weight, social and cognitive parameters; FA needs zero-distance attractiveness value and light absorption coefficient; and GSA uses the positive constants and inertia weight. These user-defined parameters do not only obstruct users from effectively tuning the algorithms, but also make them ineffective when dealing with different kinds of optimization problems because unsuitable setting parameters can create an inbalance between the exploration and exploitation capacities. Moreover, many “novel” algorithms, or variants, are very complicated or just metaphors of some basic others, which causes significant challenges for users in choosing a suitable method. Therefore, the motivation for constructing simple parameter-less or parameter-free meta-heuristic optimization techniques is really significant.

The behaviors of nature have been the greatest inspiration of researchers for developing meta-heuristic optimization algorithms during the last decades. It is observed that for a narrow class of phenomenon, a particular mechanism based on natural development always tends to a better situation by the time. However, when that mechanism is applied to other problems, the assumption may not be true. In other words, natural-based development mechanisms can be only good for each corresponding specific phenomenon. So it is reasonable to state that they are not suitable for solving many different problems. No Free Lunch theorem also indicated that there is no unique technique to perfectly solve all optimization problems. From these perspective, there is a need to find a solution for a meta-heuristic optimization algorithm that can make self-balance between their diversification and intensification during the search process instead of just strictly mimicking any “seem-to-be-optimal” behaviors from nature.

### SUMMARY

In accordance with a first aspect of the invention, there is disclosed a method for determining an objective solution for generating an optimized value for an objective function therefrom, the objective solution being represented by location of a global optimal solution point O in a d-dimensional solution space S and being searchable by a plurality of solution candidates associated with the objective function, each of the plurality of solution candidates xᵢ having a d-dimensional value representing the position thereof in the solution space S . The method comprises initialising the first of the plurality of solution candidates with a trial value xₒᵢₙ^{t}, each of the plurality of solution candidates having an ordinal rank with the first of the plurality of solution candidates having the highest ordinal rank. The method further comprises updating the position of each of the other of the plurality of solution candidates using the position of the solution candidate having a rank that is higher thereto, determining value of objective function for each of the plurality of solution candidates, and assigning a new ordinal rank each of the plurality of solution candidate based on value of their objective function generated therefrom.

In accordance with the a second aspect of the invention, there is disclosed a machine-readable medium having stored therein a plurality of programming instructions for determining an objective solution for generating an optimized value for an objective function therefrom, the objective solution being represented by location of a global optimal solution point O in a d-dimensional solution space S and being searchable by a plurality of solution candidates associated with the objective function, each of the plurality of solution candidates xᵢ, having a d-dimensional value representing the position thereof in the solution space S . The programming instructions, when executed, cause the machine to initialise the first of the plurality of solution candidates with a trial value xₒᵢₙ^{t}, each of the plurality of solution candidates having an ordinal rank with the first of the plurality of solution candidates having the highest ordinal rank. The programming instructions, when executed, cause the machine further to update the position of each of the other of the plurality of solution candidates using the position of the solution candidate having a rank that is higher thereto, determine value of objective function for each of the plurality of solution candidates, and assign a new ordinal rank each of the plurality of solution candidate based on value of their objective function generated therefrom.

### BRIEF DESCRIPTION OF THE DRAWINGS

For a better understanding of the present disclosure, non-limiting and non-exhaustive embodiments are described in reference to the following drawings. In the drawings, like reference numerals refer to parts through all the various figures unless otherwise specified.

FIG. 1 shows a process flow diagram of a method for determining an objective solution for generating an optimized value for an objective function therefrom, also known as an optimization method and further known as balanced composite motion optimization (BCMO) process, in accordance with an aspect of the invention;

FIG. 2 illustrates composite motion of the i^{th} individual in the BCMO process for a two-dimensional case and a vector scheme of four possible movement vectors for a solution candidate/individual for application of the optimization method of FIG. 1;

FIG. 3 shows an overall flowchart of the BCMO process with multiple generations of solution candidates where the process flow of FIG. 1 is reiterated for each generation;

FIG. 4 shows convergence history of the best optimal result obtained by the BCMO process of FIG. 3 for a tension/compression spring design problem;

FIG. 5 shows convergence history of the best optimal result obtained by BCMO process of FIG. 3 for a welded beam design problem; and

FIG. 6 shows convergence history of the best optimal result obtained by the BCMO process of FIG. 3 for a pressure vessel design problem.

### DETAILED DESCRIPTION

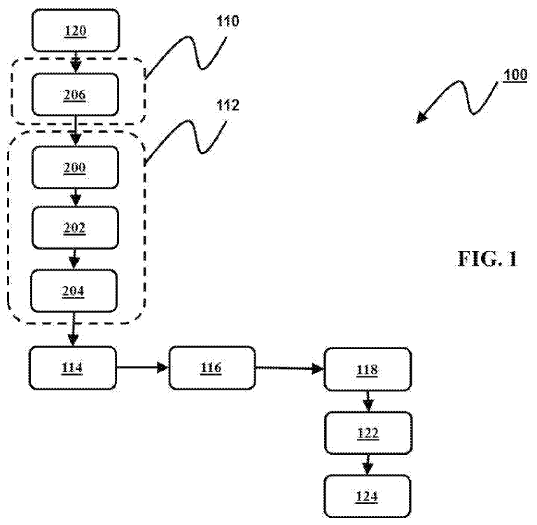

An exemplary embodiment of the present invention, a method for determining an objective solution for generating an optimized value for an objective function therefrom (“the optimization method”) 100, is described hereinafter with reference to FIG. 1 to FIG. 6.

The optimization method 100 employs a solution space system 20 for mapping candidates for solutions (“solution candidates 22”) in a solution space 24 and their movement vectors 26 as the solution candidates, specifically a plurality thereof, as they approach the objective solution. The objective solution is being represented by location of a global optimal solution point O (also known as “the global optimal solution point 28”) in a d-dimensional solution space S (also referred to as the solution space 20) and being searchable by the plurality of the solution candidates 22 associated with the objective function. Each of the plurality of solution candidates 22 (represented by the symbol “xᵢ”) having a d-dimensional value representing the position thereof in the solution space S . The d-dimensional solution space 20 is preferably a Cartesian space with location of a global optimal solution point 28 and each of the plurality of solution candidates 22 being d-dimensional Cartesian coordinates indicative of position in the solution space 20.

The optimization method comprises a step 110 of initialising the first of the plurality of solution candidates 22 with a trial value xₒᵢₙ^{t}, each of the plurality of solution candidates having an ordinal rank with the first of the plurality of solution candidates having the highest ordinal rank. Next in a step 112, the position of each of the other of the plurality of solution candidates are updated using the position of the solution candidate having a rank that is higher thereto. The value of objective function for each of the plurality of solution candidates 22 is then determined in a step 114. A new ordinal rank is then assigned to each of the plurality of solution candidate 22 in a step 116 based on value of their objective function generated therefrom. The optimization method 100 further comprises a step 118 of presenting values of one of the plurality of solution candidates 22 with the highest new ordinal rank as the optimal solution.

The step 112 of updating the position of the other of the plurality of solution candidates xᵢ, using the position of the solution candidate having a rank that is higher thereto comprises a step 200 of determining transportation motion vᵢ of the plurality of solution candidates xᵢ with vᵢ=v_{i/j}+vⱼ. v_{i/j} is the relative movement vector of the i^{th} one of the plurality of solution candidates with respect to the j^{th} one thereof, where vᵢ, and vⱼ are respectively the movement vector of the i^{th} one and j^{th} one of the plurality of solution candidates with respect to O, and the ordinal rank of the j^{th} one of the plurality of solution candidates being higher than the ordinal rank of the i^{th} one of the plurality of solution candidates.

The step 112 of updating the position of the other of the plurality of solution candidates xᵢ, using the position of the solution candidate having a rank that is higher thereto further comprises a step 202 of determining vⱼ=αⱼ(xₒᵢₙ−xⱼ) with αⱼ=L_{GS}×dvⱼ, and a step 204 of determining v_{i/j}=αᵢⱼ(xⱼ−xᵢ) with αᵢⱼ=L_{LS}×dvᵢⱼ. Preferably, L_{GS} is the global step size scaling the movement of the j^{th} one of the plurality of solution candidate, and dvⱼ, is a direction vector, and where L_{LS} is substantially 1 with dvᵢⱼ being a direction vector between the i^{th} one and j^{th} of the plurality of solution candidates.

Preferably,

$$\begin{matrix}{L}_{GS} = \{ \begin{matrix}{e}^{- \frac{1}{d} \frac{j}{NP} {r}_{j}^{2}} & if {TV}_{j} > 0.5 \\ {e}^{- \frac{1}{d} ( 1 - \frac{j}{NP} ) {r}_{j}^{2}} & otherwise\end{matrix} , and \\ {dv}_{j} = \{ \begin{matrix}rand ( 1 , d ) & if {TV}_{j} > 0.5 \\ - rand ( 1 , d ) & otherwise\end{matrix}\end{matrix}$$

wherein d is the number of dimensions, NP is the population size, rand(1,d) is the d-dimensional vector with its components distributed in a range of [0, 1], and rⱼ=∥xⱼ−xₒᵢₙ∥. The step 110 of initialising the first of the plurality of solution candidates with a trial value xₒᵢₙ^{t} comprises a step 206 of determining

$${x}_{Oin}^{t} = \{ \begin{matrix}{u}_{1}^{t} & if f ( {u}_{1}^{t} ) < f ( {x}_{1}^{t - 1} ) \\ {x}_{1}^{t - 1} & otherwise\end{matrix} .$$

Preferably, u₁^{t}=u_{c}+u_{c}+v_{k1/k2}^{t}+v_{k2/1}^{t} with u_{c} being the center point of the design space [LB,UB] and expressed as

$${u}_{c} = \frac{LB + UB}{2} .$$

Further, v_{k1/k2}^{t} and v_{k2/1}^{t} are respectively the pseudo relative movements of the one of the plurality of solution candidates with respect to the k₂^{th} one of the plurality of solution candidates and the k₂^{th} one of the plurality of solution candidates with respect to the previous best one.

The optimization method 100 further comprises a step 120 of initializing population distribution uniformly in the solution space by xᵢ=xᵢ^{L}+rand(1, d)×(xᵢ^{U}−xᵢ^{L}), wherein xᵢ^{L}, xᵢ^{U} are, respectively, the lower and upper boundaries of the i^{th} one of the plurality of solution candidates; rand(1,d) is a d-dimensional vector satisfying uniform distribution in a range of [0,1].

The optimization method 100 further comprises a step 122 of determining the objective function values of each of the plurality of solution candidates, and a step 124 of ranking the plurality of solution candidates based on the objective function values associated with each thereof by sorting f(x) where x=arg sort{f(x)}.

The optimization method 100 may be provided in the form of a machine-readable medium having stored therein a plurality of programming instructions for determining an objective solution for generating an optimized value for an objective function, the objective solution being represented by location of a global optimal solution point O in a d-dimensional solution space S and being searchable by a plurality of solution candidates associated with the objective function, each of the plurality of solution candidates xᵢ having a d-dimensional value representing the position thereof in the solution space S , the programming instructions, when executed, cause the machine to initialise the first of the plurality of solution candidates with a trial value xₒᵢₙ^{t} , each of the plurality of solution candidates having an ordinal rank with the first of the plurality of solution candidates having the highest ordinal rank. The programming instructions, when executed, cause the machine further to update the position of the other of the plurality of solution candidates using the position of the solution candidate having a rank that is higher thereto, determine value of objective function for each of the plurality of solution candidates, and assign a new ordinal rank for each of the plurality of solution candidate based on value of their objective function.

The motivation for the optimization method 100 is that in population-based optimization algorithms, solution candidates are usually generated in the solution space S and that some movement mechanisms are employed to find the global optimal region. For multimodal optimization problems, which contain many local optimal regions in the solution space, the location of O is usually unknown. The more the local optimal regions are, the more complicated and time-consuming the optimization problems are. However, the local regions can be ranked based on their corresponding solution qualities owned. This statement is simply understood that the better the objective function value of the local optimization point is, the upper-ranked the corresponding region will be. It is also noteworthy that there is always one in the group of local optimal regions contains the global optimization point O and that the individual solution candidates 22, if it is at the location of O, clearly owns the first rank. All the aforementioned analyses reveal that a population of which individuals are ranked by their objective function values can be useful in the optimization process.

Generally speaking, an optimization problem with d design variables will be solved in a solution space S⊆R^{d}. A population-based meta-heuristic algorithm usually generates randomly solution candidates in S at the initialization step. These individuals are evolved through generations to approach the global optimal solution by some heuristic rules which are commonly inspired by nature. According to the physical perspective, the solution candidates can be considered as particles and heuristic rules as the “composite motions” in a “physical space”. This metaphor is beneficial because the coordinates of solutions in the Cartesian space can be synchronized as the positions of corresponding individuals in the physical space without any encoding and decoding procedures. Moreover, the variation of the individuals and the population, such as the directions of individuals and the distribution of populations, can be also directly determined via evaluating the positional shifts of the individuals which are easily obtained from the Cartesian space. All the aforementioned analyses reveal the benefits and conveniences of the proposed approach in constructing the optimization method, which may also be aptly referred to the balancing composite motion optimization (or “BCMO” in short) algorithm.

In reiterating the aforedescribed optimization method 100, or BCMO process/algorithm, the step 120 may be referred to as an initialization step where at first generation of the solution candidates 22, the population distribution is initialized uniformly in the solution space according to the following equation:

xᵢ=xᵢ^{L}+rand(1, d)×(xᵢ^{U}−xᵢ^{L}) [Equation 1]

xᵢ^{L}, xᵢ^{U} are, respectively, lower and upper boundaries of the i^{th} individual and rand is a d-dimensional vector satisfying uniform distribution in a range of [0,1]. For clarity, an individual refers to the individual one of the plurality of solution candidates 22 with the i^{th} individual being the i^{th} highest ranked one of the plurality of solution candidates 22.

The objective function values of the population f(x) is then evaluated and all individuals are ranked based on sorting f(x) as follows:

x=arg sort{f(x)} [Equation 2]

In BCMO, individuals in the population are ranked based on their objective function values at each generation. It is noted that we have an NP-ranked individual and they are located at different local optimal regions in the solution space S . The individuals with better objective function values own the higher ranks (or higher ordinal ranks). These individuals will move as particles in S to find out the optimal solution. Considering an i^{th} individual (i>0) in S at each generation, its absolute movement can be derived as a two-component composite motion involving a relative motion with respect to the better j^{th} ranking (j<i or j=i=1) and a transportation motion of the j^{th} individual with respect to the global optimization point O which can be represented as:

vᵢ=v_{i/j}+vⱼ [Equation 3]

v_{i/j} is the relative movement vector of the i^{th} individual with respect to the j^{th} one, vᵢ and vⱼ are respectively the movement vector of the i^{th} and j^{th} individuals with respect to O.

However, there is generally no way to predetermine the location of O. Hence, Equation 3 for calculating vᵢ seems to be useless. To overcome this restriction, let us define the “instant global optimization” point Oᵢₙ in order to replace the exact global optimization point O. The simplest way to determining Oᵢₙ at the t^{th} generation is to define it by the best individual at the previous generation x₁^{t-1}. However, if Oᵢₙ is simply assigned using xₒᵢₙ^{t}=x₁^{t-1}, and x₁^{t-1} is not updated through the last generation, for whatever reason, the optimization method 100, or BCMO algorithm, will prematurely converge.

Therefore, the step 110, which may be referred to as a step for determination of an instant global point and the best individual, may be applied where an updated Oᵢₙ at the t^{th} generation should be determined via a selection between the previous best x₁^{t-1} with respect to a trial individual u₁^{t} based on their objective function values as follows:

$${x}_{Oin}^{t} = \{ \begin{matrix}{u}_{1}^{t} & if f ( {u}_{1}^{t} ) < f ( {x}_{1}^{t - 1} ) \\ {x}_{1}^{t - 1} & otherwise\end{matrix} \qquad [ Equation 4 ]$$

Preferably, u₁^{t} is determined by using the population information of the previous generation as follows:

u₁^{t}−u_{c}+v_{k1/k2}^{t}+v_{k2/1}^{t} [Equation 5]

u_{c}, is the center point of the design space [LB,UB] and can be simply expressed by:

$${u}_{c} = \frac{LB + UB}{2} \qquad [ Equation 6 ]$$

V_{k1//k2}^{t} and v_{k2/1}^{t} are respectively the pseudo relative movements of the k₁^{th} individual with respect to the k₂^{th} one of the individuals, and the k₂^{th} individual with respect to the previous best one of the individuals. It is noted that k₁ is randomly chosen in a range of [2, NP], k₂ <k₁, and v_{k1/k2}^{t} and v_{k2/1}^{t} are derived from the following Equations 12 to 13 with L_{LS}=1.

In Equation 5, the trial vector u₁^{t} a can be realized as the composite motion of the individual with respect to Oᵢₙ. This demonstrates the exploration and exploitation abilities of the trial mechanism via balancing the global search of the k₂^{th} individual for Oᵢₙ, and local search of the k₁^{th} individual for the individual. However, the composite vector v_{k1/k2}^{t}+v_{k2/1}^{t} is displaced to the center point of the design space u_{c}. Because the design space is symmetric with respect to the u_{c}, the trial position u₁^{t} can be unbiasedly generated in the search space to increase the probability to find unknown better Oᵢₙ through subsequent generations.

In the optimization method 100, or BCMO algorithm, x₁^{t} is directly assigned by x₁ₒ^{t}. An advantage of this assignment is that the Oᵢₙ is saved and updated by the best current individual during the optimization process via Equation 4. In addition, it does not need any variables or programming steps to store the history of Oᵢₙ. The required computer resource is thus reduced, especially for the cases that the dimension of optimization problems or the required number of optimization iterations is large. The determination mechanism for Oᵢₙ and the best individual at the t^{th} generation is described in the Algorithm 1 as shown in the pseudo code thereof:

[Algorithm 1]

In determining Oᵢₙ and x₁^{t} at t^{th} generation
{

INPUT: x₁^{t-1}
Generate u₁^{t} by Equations 5 and 6
Calculate f(u₁^{t})
Determine x_{Oin}^{t} by Equation 4
Assign x₁^{t} = x_{Oin}^{t}
OUTPUT: x_{Oin}^{t}, x₁^{t}

)

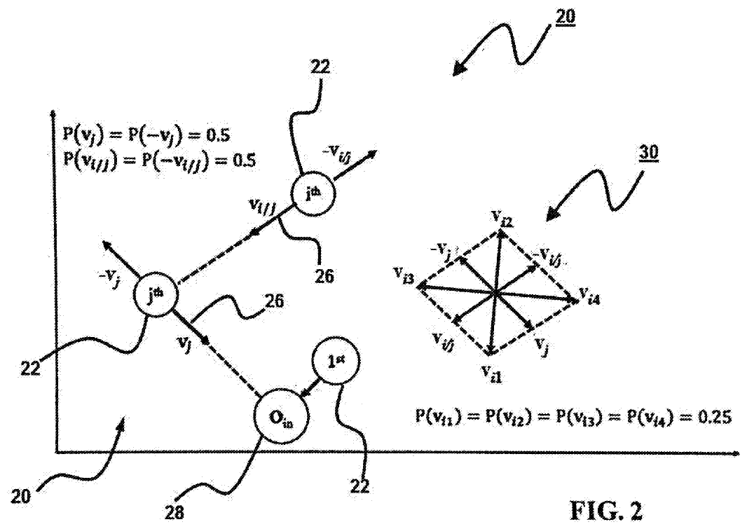

In the step 110, which may be referred to as a step for determination of composite motion of individuals in solution space, the i^{th} individual (expect the best individual) can move towards or move away to the better j^{th} one as well as the point Oᵢₙ in S . Regarding Equation 3, it is easily seen that the relative motion defined by v_{i/j} is a local search which can make the i^{th} individual exploit or explore around the j^{th} one based on the direction of v_{i/j}. Specifically, when v_{i/j} is positive, the i^{th} individual will come closer to locally exploit the optimal region of the j^{th} one. On the contrary, the i^{th} individual will come far away to j^{th} one for exploring further when v_{i/j} is negative. Similarly, the transportation motion vⱼ may be considered as a global search which also makes the j^{th} individual have an opportunity to come closer to or move further away from the instant global optimization point Oᵢₙ through every generation. To totally balance the exploration and exploitation abilities of each individual in the search space, the probabilities for assigning the positive and negative signs of v_{i/j} and vⱼ in both local and global searches should be equal as shown in FIG. 2.

In BCMO, the movement of the global search yⱼ are calculated by

vⱼ=αⱼ(xₒᵢₙ−xⱼ) [Equation 7]

αⱼ is regarded as the first-order derivative of the movement distance (xₒᵢₙ−xⱼ) and determined as follows:

αⱼ=L_{GS}×dvⱼ [Equation 8]

L_{GS} is the global step size scaling the movement of the j^{th} individual, and dvⱼ is a direction vector which its sign is positive or negative with a probability of 0.5. L_{GS} and dvⱼ are determined via a trial number TV_{j,} generated uniformly from 0 to 1 as follows:

$$\begin{matrix}{L}_{GS} = \{ \begin{matrix}{e}^{- \frac{1}{d} \frac{j}{NP} {r}_{j}^{2}} & if {TV}_{j} > 0.5 \\ {e}^{- \frac{1}{d} ( 1 - \frac{j}{NP} ) {r}_{j}^{2}} & otherwise\end{matrix} & [ Equation 9 ] \\ {dv}_{j} = \{ \begin{matrix}rand ( 1 , d ) & if {TV}_{j} > 0.5 \\ - rand ( 1 , d ) & otherwise\end{matrix} & [ Equation 10 ]\end{matrix}$$

d is the number of dimensions, NP is the population size, and rand(1,d) is the d-dimensional vector with its components distributed in a range of [0, 1]. rⱼ is the norm of the distance from the j^{th} individual to Oᵢₙ and being a norm on L₁. rⱼ is calculated by:

rⱼ∥xⱼ−xₒᵢₙ∥₁ [Equation 11]

In Equations 7 and 8, the global step size L_{GS} is multiplied to vⱼ in order to determine the impact of the variety of the population (population size NP), the problem of interests (number of dimensions d) and the location of its individual in the search space (j and rⱼ) with respect to the destination Oᵢₙ. Some detailed explanations for calculating the step size L_{GS} presented in Equation 9 are provided here. If the dimension of optimization problem d is increased, which means that the scale of S is greatly increased, the global step size also grows respectively to be suitable with the extreme enlargement of S . In addition, the rank of the individual in the population and the correlations with respect to the instant global optimization point Oᵢₙ (by three parameters NP, j and rⱼ in Equation 9 and Equation 11) also impact to the value of L_{GS}. It is seen that if the j^{th} individual is close to Oᵢₙ (j <<NP and rⱼ is respectively small), it is greatly attracted by Oᵢₙ because the corresponding L_{GS} approaches to 1 in this case. Conversely, L_{GS} is significantly small with respect to the j^{th} individual which is far from Oᵢₙ ((NP−j)<<NP and rⱼ is respectively high) to reduce the affection of the global search for avoiding trapping itself by the local optimal solutions in the cases that Oᵢₙ is not still located in the global optimal region. From all the aforementioned analyses, it is realized that the global step size L_{GS} also implicitly regulates for each individual of the searching domains as well as the exploitation and exploration abilities in the phase of global search during the optimization process. Similar to vⱼ, the relative movement v_{i/j} can be determined from two ones xᵢ and xⱼ as follows:

v_{i/j}=αᵢⱼ(xⱼ−xᵢ) [Equation 12]

αᵢⱼ is provided by the following equation:

xᵢ^{t+1}=xᵢ^{t}+v_{i/j}+vⱼ [Equation 15 ]

L_{LS} can be fixed at 1 for balancing the local exploration and exploitation abilities of the i^{th} individual, dvᵢⱼ is a direction vector between the i^{th} and j^{th} individuals and it is computed similarly using Equation 10.

The general movement mechanism of the i^{th} individual in the solution space system using BCMO for the two-dimensional case is illustrated in FIG. 2. The left portion of FIG. 2 illustrates interactions of individuals and the instant global optimal point Oᵢₙ, while the right portion of FIG. 2 shows a vector scheme 30 of four possible movement vectors with respect to the i^{th} individual which are generated from v_{i/j} and vⱼ. From the vector scheme 30 in FIG. 2, it is seen that vᵢ₁ is the case which always makes the i^{th} individual directly come closer to the regions of Oᵢₙ and the j^{th} individual. The magnitude of V_{i/j} is usually higher the one of vⱼ due to the dominance of the magnitude of α_{i/j} with respect to the one of αⱼ (see Equation 8 and Equation 13). As opposed to vᵢ₁, vᵢ₂ always make the i^{th} individual move away to Oᵢₙ and the j^{th} individual. Similarly, vᵢ₃ enhances the i^{th} individual to come closer to the j^{th} individual and slightly avoids Oᵢₙ, and vᵢ₄ is completely the opposite case of vᵢ₃. From these abovementioned remarks, it can be clearly classified that vᵢ₁ and vᵢ₂ are respectively the global exploitation and exploration movements of the i^{th} individual in S . Likewise, the local exploitation and exploration movement are correspondingly assigned to vᵢ₃ and vᵢ₁ and vᵢ₄ vᵢ₂. Moreover, it is also noteworthy that the probabilities of these cases of vᵢₖ are absolutely equal and they are calculated as follows:

P(vᵢₖ)=P(v_{i/j})×P(vⱼ)=0.5×0.5=0.25 k=1, . . . , 4 Equation [14]

Therefore, a probabilistic balance between the exploration and exploitation for both the global and local search is always maintained with respect to each individual in the population (except the best individual, or the best one of the plurality of solution candidates 22). The updated position of the i^{th} individual at the next generation is expressed as:

xᵢ^{t+1}=xᵢ^{t}+v_{i/j}+vⱼ [Equation 15]

The composite motions of individuals in the population is described in the Algorithm 2 as shown in the pseudo code below:

[Algorithm 2]

In determining movement of individuals from t^{th} generation to
(t+1)^{th} generation

{
INPUT: x^{t}
for i = 2 to NP

Calculate the global search of the i^{th} individual by Eqs.
(7) − (11)
Calculate the local search of the i^{th} individual by
Equations 12 and 13
Update the composite motion of i^{th} individual to the next
generation

by Equation 15

end for
Calculate the objective function value of population f(x^{t+1})
OUTPUT: x^{t+1}, f(x^{t+1})

)

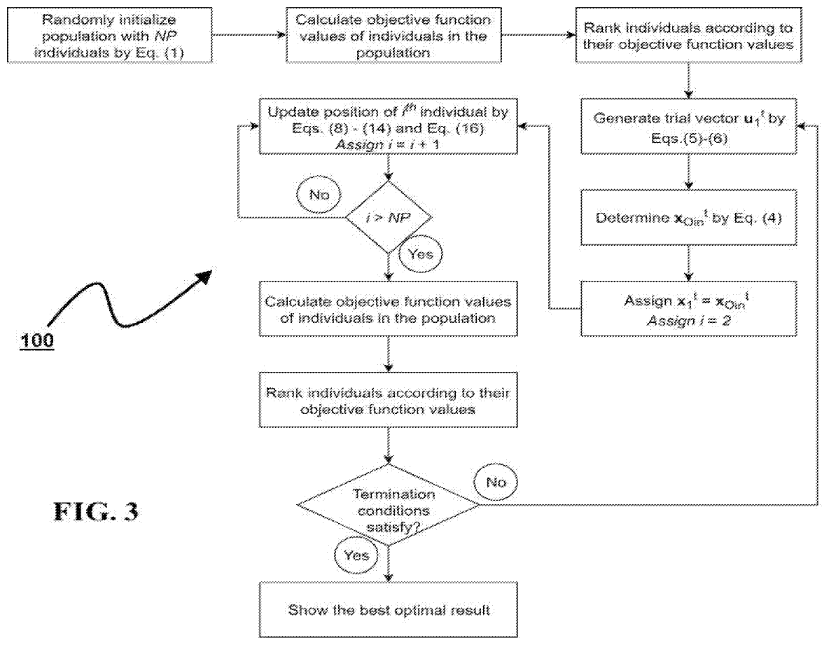

FIG. 2 illustrates an exemplary composite motion of the i^{t h} individual in BCMO in a two-dimensional case. The overall flowchart of BCMO is shown in FIG. 3 and the pseudo codes for BCMO is illustrated in Algorithm 3 below:

[Algorithm 3]

In performing the the optimization method 100 / BCMO
{
Generate the initial population by Equation 1
Calculate the objective function values of all individuals of the population
Rank the population and find the best individual
while (t < MaxGeneration)

Determine Oᵢₙ and the best individual by Algorithm 1
Update the population by Algorithm 2
Rank the individuals by their objective function values
t = t + 1

end while
Post-process and show the optimal result
}

Following the above description for the optimization method 100/BCMO, some characteristics can be observed to see how BCMO can be theoretically effective and extended for widely solving optimization problems. BCMO is a parameter-less optimization algorithm. This highly facilitates the users for applying BCMO to solve a wide range of optimization problems. Also, BCMO is a non-linear self-organizing system via the equalization between exploration and exploitation abilities which are guaranteed by a mathematic model based on the random probabilistic test. It can also be noted that the above proposed probabilistic balancing model can be a general framework to develop further optimization methods towards this approach. Further, BCMO owns both mutation and crossover mechanisms. The mutation phase for exploring the search space can be seen as the movements of individuals which come far away from the better ones and/or Oᵢₙ, while the crossover phase for exploiting the search space can be supplied by movements of individuals which come close to the better ones and/or Oᵢₙ. They are implicitly balanced based on the probabilistic selection model. It is further noted that the probabilistic threshold of 0.5 for selecting its mutation and crossover phases can be adjusted. It shows that although

BCMO is a strictly self-balancing system, it is also flexible. However, in the spirit of equalizing global and local search phases as well as mutation and crossover mechanisms, we propose to use its value of 0.5 to solve general-purpose optimization problems.

The high reliability of BCMO through real-world applications. Three well-known mechanical problems considered in this section are (1) tension/compression spring, (2) welded beam, and (3) pressure vessel with reference to the articles “Askarzadeh, A novel metaheuristic method for solving constrained engineering optimization problems: Crow search algorithm, Comput. Struct. 169 (2016) 1-12”; “A. Kaveh, T. Bakhshpoori, A new metaheuristic for continuous structural optimization: water evaporation optimization, Struct. Multidiscip. Optim. 54 (2016) 23-43”; and “B. Akay, D. Karaboga, Artificial bee colony algorithm for large-scale problems and engineering design optimization, J. Intell. Manuf. 23 (2012) 1001-1014”.

The statistical results obtained after 50 independent runs are compared with those reported in the literature. The population size NP=50 is assigned to all problems. The maximum nFES of BCMO are respectively fixed at 10000, 30000, and 25000 considering both the quality of solution and the computation cost.

In order to solve constrained optimization problems, a simple formulation of penalty function presented in the literature “V. Ho-Huu, T. Nguyen-Thoi, T. Vo-Duy, T. Nguyen-Trang, An adaptive elitist differential evolution for optimization of truss structures with discrete design variables, Comput. Struct. 165 (2016) 59-75.” is used to handle the constraint violations where:

fₚ(x)=(1+ε₁ϑ)^{ε}^{₂}×f(x), ϑ=Σᵢ₌₁^{p} max(O, gᵢ(x))+Σᵢ₌ₚ₊₁^{q} abs (hᵢ(x)) [Equation 16]

In Equation 16, x is the vector of design variables, f(x) and fₚ (x) are respectively the objective function and its corresponding penalty function, ε₁ and ε₂ are the coefficient of the penalty function, ϑ is the sum of all inequality and equality constraint violations, p and q are respectively the numbers of inequality and equality constraints. In this section, we use E₂ which linearly increases from 1 to 3 in each optimization process, and ε₁ is chosen based on the problem of interests.

For the “Tension/compression spring design problem”, the objective of this optimization problem is to minimize the mass of a tension/compression spring with respect to one linear and three nonlinear inequality constraints. The schematic design problem and its mathematical statement are in detailed presented in the literature. This problem is investigated by several studies in the literature. Nine state-of-the-art optimization methods used to compare in this section are GA4, CDE, CAEP, CPSO, SC, ABC, and CSA referenced respectively to: “C. A. C. Coello, E. Mezura-Montes, Constraint-handling in genetic algorithms through the use of dominance-based tournament selection., Adv. Eng. Informatics. 16 (2002) 193-203”; “F. zhuo Huang, L. Wang, Q. He, An effective co-evolutionary differential evolution for constrained optimization, Appl. Math. Comput. 186 (2007) 340-356”; “C. A. Coello Coello, R.L. Becerra, Efficient evolutionary optimization through the use of a cultural algorithm, Eng. Optim. 36 (2004) 219-236”; “Q. He, L. Wang, An effective co-evolutionary particle swarm optimization for constrained engineering design problems, Eng. Appl. Artif. Intell. 20 (2007) 89-99”; “T. Ray, K. M. Liew, Society and civilization: An optimization algorithm based on the simulation of social behavior, IEEE Trans. Evol. Comput. 7 (2003) 386-396”; “B. Akay, D. Karaboga, Artificial bee colony algorithm for large-scale problems and engineering design optimization, J. Intell. Manuf. 23 (2012) 1001-1014”; and “A. Askarzadeh, A novel metaheuristic method for solving constrained engineering optimization problems: Crow search algorithm, Comput. Struct. 169 (2016) 1-12”.

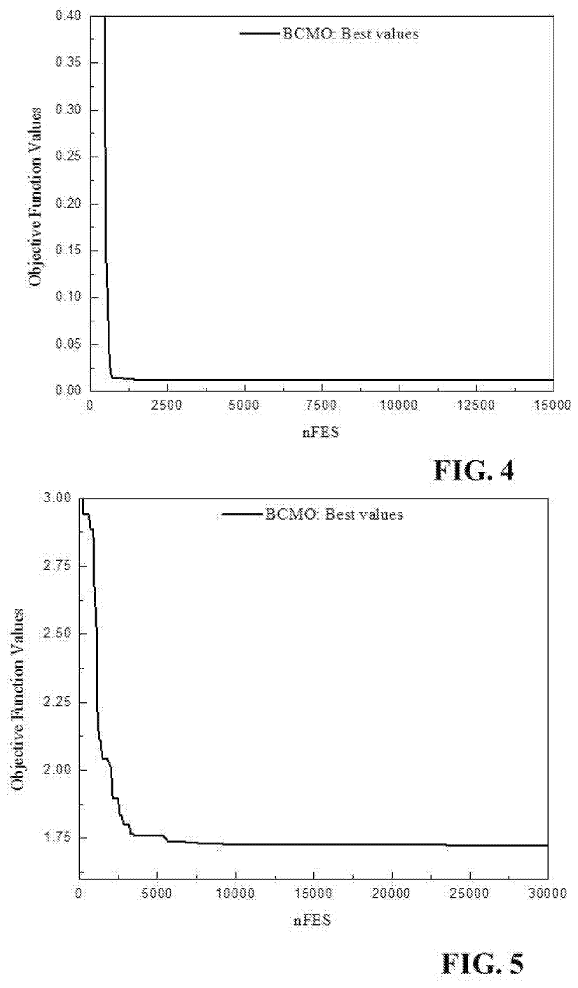

Table 1 shows the best optimal result obtained by BCMO with the corresponding values of constraint violations. Table 2 provides a comparison between BCMO and optimization methods in the literature for the tension/compression spring design optimization problem. It is seen that the best optimal result by BCMO is very competitive with those gained by ABC and CSA, and better than the remaining ones. In terms of the average optimal values after 50 optimization runs, BCMO proves better than CAEP, SC and (μ+λ,)-ES, and slightly worse than the rest. However, it is interesting to emphasize the lowest computational cost of BCMO which only uses the maximum 15000 function evaluations. In addition, the convergence history of BCMO, as shown in FIG. 4, highlights that BCMO converges to the near-optimal result very early in the optimization process. Generally, the statistical optimal results gained by BCMO are very competitive in comparison with those resulted in many optimization algorithms in the literature.

TABLE 1
Best optimal result obtained by BCMO for tension/compression spring design

| Parameters | x₁ | x₂ | x₃ | g₁ |
|---|---|---|---|---|
| Value | 0.0516597413 | 0.3560124935 | 11.3304429494 | 0.00E+00 |

| Parameters | g2 | g3 | g4 | f |
|---|---|---|---|---|
| Value | −6.74E−07 | −4.05E+00 | −7.28E−01 | 0.012665 |

TABLE 2
Comparison between BCMO and optimization methods
in the literature for tension/compression spring

| | BCMO | GA4 | CDE | CAEP | CPSO |
|---|---|---|---|---|---|
| Worst | 0.014242 | 0.012973 | — | 0.015116 | 0.012924 |
| Average | 0.012836 | 0.012742 | 0.012703 | 0.013568 | 0.012730 |
| Best | 0.012665 | 0.012681 | 0.012670 | 0.012721 | 0.012675 |
| Std | 0.000284 | 0.000059 | — | 8.42E−04 | 0.000520 |
| nFES | 15000 | 80000 | 240000 | 50020 | 240000 |

| | SC | ABC | CSA | (μ + λ) − ES |
|---|---|---|---|---|
| Worst | 0.016717 | — | 0.012670 | — |
| Average | 0.012923 | 0.012709 | 0.012666 | 0.013165 |
| Best | 0.012669 | 0.012665 | 0.012665 | 0.012689 |
| Std | 0.000590 | 0.012813 | 0.000001 | 0.000390 |
| nFES | 25167 | 30000 | 50000 | 30000 |

For the “Welded beam design problem”, the objective of this optimization problem is to minimize the cost of a welded beam. The schematic design optimization and detailed mathematical formulation of this optimization problem are provided in the article “A. Askarzadeh, A novel metaheuristic method for solving constrained engineering optimization problems: Crow search algorithm, Comput. Struct. 169 (2016) 1-12”.

Table 3 shows the best optimal result of BCMO with no violated constraint values. The statistical optimal results gained by BCMO after 50 runs are again compared with those of GA4, CDE, CAEP, CPSO, SC, ABC, and CSA in Table 4. It is seen that BCMO is superior to GA4, CDE, CPSO, SC, and competitive with the rest in terms of the best optimal result. Considering the average result, BCMO highly outperforms other optimization algorithms except for CSA. In addition, the maximum computational cost of BCMO for solving this problem is similar to those of ABC and (μ+λ,)-ES, and significantly smaller than all remaining optimization algorithms. FIG. 5 shows the convergence history of the best optimal result gained by BCMO for this case. It again presents that BCMO requires a significantly smaller nFES (about 10000) with respect to the maximum one to obtain the near-optimal result. In summary, BCMO is well-performed in comparison with other considered methods for this engineering benchmark problem.

TABLE 3
Best optimal result obtained by BCMO for welded beam design

| Parameters | x1 | x2 | x3 | x4 | g1 | g2 |
|---|---|---|---|---|---|---|
| Value | 0.2057296526 | 3.4704890037 | 9.0366223562 | 0.2057297169 | −7.65E−05 | −9.39E−04 |
| Parameters | g3 | g4 | g5 | g6 | g7 | f |
| Value | −6.40E−08 | −3.43E+00 | −8.07E−02 | −2.36E−01 | −6.08E−03 | 1.724852 |

TABLE 4
Comparison between BCMO and optimization methods in the literature for welded beam design.

| | BCMO | GA4 | CDE | CAEP | CPSO | SC | ABC | CSA |
|---|---|---|---|---|---|---|---|---|
| Worst | 1.927573 | 1.993408 | 1.824105 | 3.179709 | 1.782143 | 6.399679 | — | 1.724852 |
| Average | 1.739332 | 1.792654 | 1.768158 | 1.971809 | 1.748831 | 3.002588 | 1.741913 | 1.724852 |
| Best | 1.724852 | 1.728226 | 1.733461 | 1.724852 | 1.728024 | 2.385435 | 1.724852 | 1.724852 |
| Std | 0.030866 | 0.074700 | 0.022194 | 4.43E−01 | 1.29E−02 | 0.960000 | 0.031000 | 0.000000 |
| nFES | 30000 | 80000 | 240000 | 50020 | 240.000 | 33095 | 30000 | 100000 |

For the “Pressure vessel design problem”, the objective of this optimization problem is to minimize the total cost including material, forming, and welding of a cylindrical vessel. The problem definition is clearly stated in the article “A. Askarzadeh, A novel metaheuristic method for solving constrained engineering optimization problems: Crow search algorithm, Comput. Struct. 169 (2016) 1-12”.

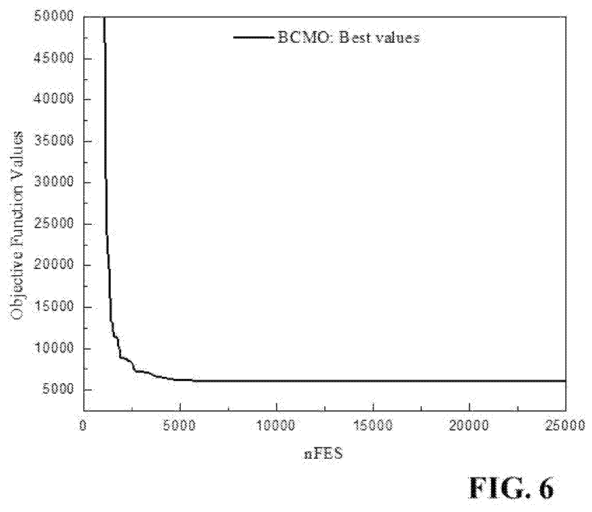

Table 5 and Table 6 respectively show the best optimal result obtained by BCMO and its comparison with other optimization methods again in the above articles referenced for GA4, CDE, CPSO, UPSO, ABC, and CSA. Table 6 shows that BCMO is better than GA4, CDE, CPSO, UPSO and competitive with the remaining ones in terms of the best optimal results after 50 runs. In addition, it is also highlighted that the maximum nFES for BCMO is the best among all selected optimization methods, and BCMO quickly converges to the near-optimal solution with an approximate nFES of 7500. They are demonstrated by the convergence history displayed in FIG. 6. The optimal results obtained by BCMO in optimization processes are sometimes trapped at some local optimum during 50 test runs, which make the higher average optimal value than those of other optimization algorithms, except UPSO. Considering all the aforementioned aspects, BCMO still performs the emulative spirit with respect to all considered optimization methods for the design optimization of the pressure vessel.

TABLE 5
Best optimal result obtained by BCMO for pressure vessel design

| Parameters | x1 | x2 | x3 | x4 | g1 |
|---|---|---|---|---|---|
| Value | 0.7789243362 | 0.3850096372 | 40.3556904385 | 199.5028780967 | −5.95E−05 |

| Parameters | g2 | g3 | g4 | f |
|---|---|---|---|---|
| Value | −1.64E−05 | −2.26E+01 | −4.05E+01 | 5887.097014 |

TABLE 6
Comparison between BCMO and optimization methods in the literature for pressure vessel design

| | BCMO | GA4 | CDE | CPSO | UPSO | ABC | CSA |
|---|---|---|---|---|---|---|---|
| Worst | 7544.493 | 6469.322 | 6371.046 | 6363.804 | 9387.77 | — | 7332.842 |
| Average | 6559.114 | 6177.253 | 6085.230 | 6147.133 | 8016.37 | 6245.308 | 6342.499 |
| Best | 6059.714 | 6059.946 | 6059.734 | 6061.077 | 6154.7 | 6059.715 | 6059.714 |
| Std | 485.6115 | 130.9297 | 43.013 | 86.45 | 745.869 | 205 | 384.9454 |
| nFES | 25000 | 80000 | 204800 | 240.000 | 100000 | 30000 | 250000 |

Hence, the optimization method 100 demonstrates a novel population-based optimization algorithm named Balancing Composite Motion Optimization (BCMO) to solve a wide range of optimization problems. In BCMO, the solution space is known as the Cartesian space and the ranked individuals of the population based on their objective function values interactively move in the solution space to find out the global optimal result. An individual, or one of a plurality of solution candidates 22, is attracted by an upper-ranked one and a so-called “instant global optimization point”. Therein, the interaction between its individual and the upper-ranked one is considered as a local search, and the remaining one is a global search. This means that an individual simultaneously conducts both global and local search in each optimization iteration. In each of two abovementioned phases, the individual also has the same probability for exploring or exploiting the considered searching domain. These lead to a strict balance between the global and local searching abilities of each individual in the solution space. Specifically, the BCMO is constructed without algorithm-specific parameters. This significantly makes the BCMO become very simple and easy to implement for solving different kinds of optimization problems. An experiment employing the BCMO to solve 3 selected engineering design problems for further validating its performance in practice. Comparing with the optimal results reported in the literature, it is seen that BCMO can effectively solve real-world design problems with constrained and unknown search spaces by better or competitive computation cost. The robustness and the programming simplicity of the BCMO presents the BCMO as an effective alternative method for solving general-purpose optimization problems among current state-of-the-art optimization algorithms.

Aspects of particular embodiments of the present disclosure address at least one aspect, problem, limitation, and/or disadvantage associated with existing optimization methods and solutions. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. A method for determining an objective solution for generating an optimized value for an objective function therefrom, the objective solution being represented by qlocation of a global optimal solution point O in a d-dimensional solution space S and being searchable by a plurality of solution candidates associated with the objective function, each of the plurality of solution candidates xᵢ having a d-dimensional value representing the position thereof in the solution space S , the method comprising:
initialising the first of the plurality of solution candidates with a trial value xₒᵢₙ^{t}, each of the plurality of solution candidates having an ordinal rank with the first of the plurality of solution candidates having the highest ordinal rank;
updating the position of each of the other of the plurality of solution candidates using the position of the solution candidate having a rank that is higher thereto;
determining value of objective function for each of the plurality of solution candidates; and
assigning a new ordinal rank to each of the plurality of solution candidate based on value of their objective function generated therefrom.

2. The method as in claim 1, further comprising:
presenting values of one of the plurality of solution candidates with the highest new ordinal rank as the optimal solution.

3. The method as in claim 1, the d-dimensional solution space S being a Cartesian space with location of a global optimal solution point O and each of the plurality of solution candidates being d-dimensional Cartesian coordinates.

4. The method as in claim 1, updating the position of the other of the plurality of solution candidates xᵢ using the position of the solution candidate having a rank that is higher thereto comprising:
determining the transportation motion vᵢ, of the plurality of solution candidates xᵢ, with v_{i/j}=vⱼ wherin v_{i/j} is the relative movement vector of the i^{th} one of the plurality of solution candidates with respect to the j^{th} one thereof, where vᵢ, and vⱼ, are respectively the movement vector of the i^{th} one and j^{th} one of the plurality of solution candidates with respect to O , and the ordinal rank of the j^{th} one of the plurality of solution candidates being higher than the ordinal rank of the i^{th} one of the plurality of solution candidates.

5. The method as in claim 4, updating the position of the other of the plurality of solution candidates xᵢ using the position of the solution candidate having a rank that is higher thereto comprising:
determining vⱼ=αⱼ(xₒᵢₙ−xⱼ) with αⱼ=L_{GS}×dvⱼ; and
determining v_{i/j}=αᵢⱼ(xⱼ−xᵢ) with αᵢⱼ=L_{LS}×dvᵢⱼ,
wherein L_{GS} is the global step size scaling the movement of the j^{th} one of the plurality of solution candidate, and dvⱼ is a direction vector, and where L_{Ls} is substantially 1 with dvᵢⱼ being a direction vector between the i^{th} one and j^{th} of the plurality of solution candidates.

6. The method as in claim 5, wherein
$$\begin{matrix}{L}_{GS} = \{ \begin{matrix}{e}^{- \frac{1}{d} \frac{j}{NP} {r}_{j}^{2}} & if {TV}_{j} > 0.5 \\ {e}^{- \frac{1}{d} ( 1 - \frac{j}{NP} ) {r}_{j}^{2}} & otherwise\end{matrix} ; and \\ {dv}_{j} = \{ \begin{matrix}rand ( 1 , d ) & if {TV}_{j} > 0.5 \\ - rand ( 1 , d ) & otherwise\end{matrix}\end{matrix}$$
and wherein d is the number of dimensions, NP is the population size, rand(1,d) is the d-dimensional vector with its components distributed in a range of [0, 1], and rⱼ=∥xⱼ−xₒᵢₙ∥.

7. The method as in claim 6, initialising the first of the plurality of solution candidates with a trial value xₒᵢₙ^{t} comprising:
$$determining {x}_{Oin}^{t} = \{ \begin{matrix}{u}_{1}^{t} & if f ( {u}_{1}^{t} ) < f ( {x}_{1}^{t - 1} ) \\ {x}_{1}^{t - 1} & otherwise\end{matrix}$$
wherein u₁^{t}=u_{c}+v_{k1/k2}^{t}+v_{k2/1}^{t} with u_{c} being the center point of the design space [LB,UB] and expressed as
$${u}_{c} = \frac{LB + UB}{2} ,$$
and
wherein v_{k1/k/2}^{t} and v_{k2/1}^{t} are respectively the pseudo relative movements of the k₁^{th} one of the plurality of solution candidates with respect to the k₂^{th} one of the plurality of solution candidates and the k₂^{th} one of the plurality of solution candidates with respect to the previous best one.

8. The method as in claim 1, further comprising:
initializing population distribution uniformly in the solution space by xᵢ=xᵢ^{L}+rand(1, d)×(xᵢ^{U}−xᵢ^{L}),
wherein xᵢ^{L}, xᵢ^{U} are, respectively, the lower and upper boundaries of the i^{th} one of the plurality of solution candidates; rand is a d-dimensional vector satisfying uniform distribution in a range of [0,1].

9. The method as in claim 8, further comprising:
determining the objective function values of each of the plurality of solution candidates; and
ranking the plurality of solution candidates based on the objective function values associated with each thereof by sorting f(x) where x =arg sort{f(x)}.

10. A machine-readable medium having stored therein a plurality of programming instructions for determining an objective solution for generating an optimized value for an objective function therefrom, the objective solution being represented by location of a global optimal solution point O in a d-dimensional solution space S and being searchable by a plurality of solution candidates associated with the objective function, each of the plurality of solution candidates xᵢ having a d-dimensional value representing the position thereof in the solution space S , the programming instructions, when executed, cause the machine to:
initialise the first of the plurality of solution candidates with a trial value xₒᵢₙ^{t}, each of the plurality of solution candidates having an ordinal rank with the first of the plurality of solution candidates having the highest ordinal rank;
update the position of each of the other of the plurality of solution candidates using the position of the solution candidate having a rank that is higher thereto;
determine value of objective function for each of the plurality of solution candidates; and
assign a new ordinal rank each of the plurality of solution candidate based on value of their objective function generated therefrom.

11. The machine-readable medium as in claim 10, the programming instructions, when executed, cause the machine further to:
present values of one of the plurality of solution candidates with the highest new ordinal rank as the optimal solution.

12. The machine-readable medium as in claim 10, the d-dimensional solution space S being a Cartesian space with location of a global optimal solution point O and each of the plurality of solution candidates being d-dimensional Cartesian coordinates.

13. The machine-readable medium as in claim 10, the programming instructions, when executed, cause the machine further to:
determine the transportation motion vᵢ, of the plurality of solution candidates xᵢ with vᵢ=v_{i/j}+vⱼ wherin v_{i/j} is the relative movement vector of the i^{th} one of the plurality of solution candidates with respect to the j^{th} one thereof, where vᵢ and vⱼ are respectively the movement vector of the i^{th} one and j^{th} one of the plurality of solution candidates with respect to O, and the ordinal rank of the j^{th} one of the plurality of solution candidates being higher than the ordinal rank of the i^{th} one of the plurality of solution candidates.

14. The machine-readable medium as in claim 13, the programming instructions, when executed, cause the machine further to:
determine vⱼ=α(xₒᵢₙ−xⱼ) with αⱼ=L_{GS}×dvⱼ; and
determine v_{i/j}=αᵢⱼ(xⱼ−xᵢ) with αᵢⱼ=L_{LS}×dvᵢⱼ,
wherein L_{GS} is the global step size scaling the movement of the j^{th} one of the plurality of solution candidate, and dvⱼ is a direction vector, and where L_{LS} is substantially 1 with dvᵢⱼ being a direction vector between the i^{th} one and j^{th} of the plurality of solution candidates.

15. The machine-readable medium as in claim 14, wherein
$$\begin{matrix}{L}_{GS} = \{ \begin{matrix}{e}^{- \frac{1}{d} \frac{j}{NP} {r}_{j}^{2}} & if {TV}_{j} > 0.5 \\ {e}^{- \frac{1}{d} ( 1 - \frac{j}{NP} ) {r}_{j}^{2}} & otherwise\end{matrix} ; and \\ {dv}_{j} = \{ \begin{matrix}rand ( 1 , d ) & if {TV}_{j} > 0.5 \\ - rand ( 1 , d ) & otherwise\end{matrix}\end{matrix}$$
and wherein d is the number of dimensions, NP is the population size, rand(1,d) is the d-dimensional vector with its components distributed in a range of [0, 1], and rⱼ=∥xⱼ−xₒᵢₙ∥.

16. The machine-readable medium as in claim 15, the programming instructions, when executed, cause the machine further to:
$$determining {x}_{Oin}^{t} = \{ \begin{matrix}{u}_{1}^{t} & if f ( {u}_{1}^{t} ) < f ( {x}_{1}^{t - 1} ) \\ {x}_{1}^{t - 1} & otherwise\end{matrix}$$
wherein u₁^{t}=u_{c}+v_{k1/k2}^{t}+v_{k2/1} with u_{c}, being the center point of the design space [LB,UB] and expressed as
$${u}_{c} = \frac{LB + UB}{2} ,$$
and
wherein v_{k1/k2}^{t} and v_{k2/1}^{t} are respectively the pseudo relative movements of the k₁^{th} one of the plurality of solution candidates with respect to the k₂^{th} one of the plurality of solution candidates and the k? one of the plurality of solution candidates with respect to the previous best one.

17. The machine-readable medium as in claim 16, the programming instructions, when executed, cause the machine further to:
initialize population distribution uniformly in the solution space by xᵢ=xᵢ^{L}+rand(1, d)×(xᵢ^{U}−xᵢ^{L});
determine the objective function values of each of the plurality of solution candidates; and
rank the plurality of solution candidates based on the objective function values associated with each thereof by sorting f(x) where x=arg sort{f(x)},
wherein xᵢ^{L}, xᵢ^{U} are, respectively, the lower and upper boundaries of the i^{th} one of the plurality of solution candidates; rand is a d-dimensional vector satisfying uniform distribution in a range of [0,1].
